(19) United States
(12) Patent Application Publication
(10) Pub. No.: US 2026/0166959 A1
(43) Pub. Date: Jun. 18, 2026

(54) VEHICLE WITH WIRELESS FOOT WARMING SYSTEM

(71) Applicant: FCA US LLC, Auburn Hills, MI (US)

(72) Inventors: Gary M.C. Starnes, Auburn Hills, MI (US); Aniket Wankhede, Auburn Hills, MI (US); Sangamitra Reddy Gattikoppula, Auburn Hills, MI (US); Anesh Basheer, Auburn Hills, MI (US)

(21) Appl. No.: 18/981,971

(22) Filed: Dec. 16, 2024

(51) Int. Cl. B60H 1/22; B60N 3/04; B60R 16/033

(52) U.S. Cl. CPC B60H 1/2215; B60N 3/048; B60R 16/033

(57) ABSTRACT

In at least some implementations, a vehicle includes a cabin having a seat and a footwell associated with the seat, and an inductive heating source. The inductive heating source has an electrical supply and one or more coils located in the footwell and connected to the electrical supply. When an alternating current is provided to the one or more coils, the one or more coils emit one or more magnetic fields adapted to enable inductive heating of a heating element in the one or more magnetic fields.

### FIELD

The present disclosure relates to a vehicle having a wireless foot warming system.

### BACKGROUND

In cold weather, a vehicle passenger's feet can get very cold. Especially for people working outdoors or otherwise outdoors for extended periods of time, having the ability to quickly and reliably heat feet can provide a significant improvement in comfort. Convective and radiant heating assemblies can be slow to respond and slow to provide sufficient heat, especially to a person's feet which may be within shoes.

### SUMMARY

In at least some implementations, a vehicle includes a cabin having a seat and a footwell associated with the seat, and an inductive heating source. The inductive heating source has an electrical supply and one or more coils located in the footwell and connected to the electrical supply. When an alternating current is provided to the one or more coils, the one or more coils emit one or more magnetic fields adapted to enable inductive heating of a heating element in the one or more magnetic fields. The one or more coils may be carried by or otherwise associated with a floor mat in the vehicle.

In at least some implementations, the floor mat is received in the foot well, and the floor mat carries the one or more coils. In at least some implementations, the floor mat includes an upper layer of material that defines an upper surface of the floor mat on which a foot of a passenger may be received, and the one or more coils are received beneath the upper layer of material. In at least some implementations, the floor mat includes a second layer of material that is beneath the upper layer of material, and wherein the one or more coils are received between the second layer of material and the upper layer of material. In at least some implementations, the one or more coils are overmolded into the floor mat.

In at least some implementations, the footwell is defined at least in part by a floor of the vehicle and the vehicle includes a floor covering on the floor, and wherein the one or more coils are received between the floor and the floor covering.

In at least some implementations, multiple coils are provided in the footwell, the multiple coils including individual coils that are spaced apart from each other and are received in an area of at least 20 in².

In at least some implementations, a controller is coupled to the electrical supply and to the one or more coils, and the controller is adapted to control the magnitude or frequency or both of the electricity supplied to the one or more coils.

In at least some implementations, a floor mat for a vehicle includes an upper layer of material that defines an upper surface of the floor mat adapted to receive a foot of a vehicle passenger may be received, and one or more coils of wire. The coils are adapted to be connected to a source of alternating current and to emit one or more magnetic fields adapted to enable inductive heating of a heating element in the one or more magnetic fields, and the one or more coils are received beneath the upper surface of the floor mat.

In at least some implementations, the one or more coils are received beneath the upper layer of material.

In at least some implementations, the floor mat includes a second layer of material that is beneath the upper layer of material, and the one or more coils are received between the second layer of material and the upper layer of material.

In at least some implementations, the floor mat is defined by or includes a polymeric layer and the one or more coils are overmolded into the polymeric layer.

In at least some implementations, a controller is associated with the floor mat and is coupled to the one or more coils and arranged to control one or both of a magnitude and frequency of the alternating current supplied to the one or more coils.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of part of a passenger cabin of a vehicle;

FIG. 2 is a perspective view of multiple floor mats of the vehicle;

FIG. 3 is a perspective view of a first one of the floor mats;

FIG. 4 is a sectional view of part of the floor mat of FIG. 3;

FIG. 5 is a plan view of a shoe insert carrying a heating element;

FIG. 6 is a plan view of a shoe insert with a heating element formed as part of a layer of the shoe insert; and

FIG. 7 is side view of a shoe including a heating element.

### DETAILED DESCRIPTION

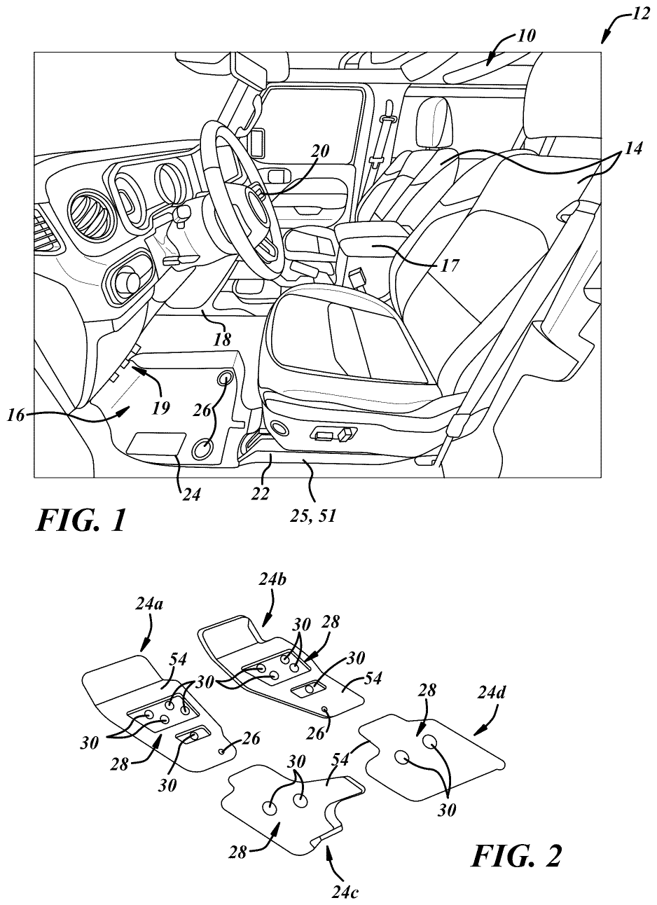

Referring in more detail to the drawings, FIG. 1 illustrates part of an interior cabin 10 of a vehicle 12. The cabin 10 includes multiple seats 14 arranged in one or more rows, and corresponding footwells 16 or foot areas in which the feet of a vehicle passenger may be received when the passenger is seated on a seat 14. Each seat 14 may have a corresponding footwell 16 or area located and arranged to receive one or more feet of a passenger, as desired. The footwells 16 or foot areas of adjacent seats 14 may be contiguous, without any dividing wall, or they may be separated from each other. For example, some vehicles include a center console 17 and/or center tunnel 18 (e.g. to accommodate drivetrain components extending from a front of the vehicle 12 toward a rear of the vehicle 12) that separates the footwells 16 associated with the front row of seats 14, and possibly other seats as well. The footwell 16 in the area of a driver's seat 14 may have driving controls 19, such as accelerator, brake and/or clutch pedals extending into the footwell 16, and a steering input 20 (e.g. steering wheel) may be mounted above the footwell 16 and near a corresponding seat 14.

The footwells 16 are defined by a vehicle floor 22 which may be covered at least partially by a floor mat 24, and/or by interior carpet or other floor covering 25 that may be secured within the passenger cabin 10. The floor mats 24 may be removable from the vehicle 12 to facilitate cleaning or replacing them. To facilitate removal and retention of the floor mats 24, they may be releasably secured to the vehicle floor 22, such as by clips or other connector 26, or they may be simply placed on the vehicle floor 22 in some implementations. The footwells 16 associated with different seats 14 may have differently shaped floor areas and the floor mats 24 or other covering may be shaped accordingly, or two or more of the floor mats 24 may have the same shape, as desired. FIG. 2 shows a first floor mat 24a configured for receipt on the vehicle floor 22 in a first footwell 16 that is located by a left side seat 14 in a front row of vehicle seats 14, a second floor mat 24b configured for receipt on the vehicle floor 22 in a second footwell 16 that is located by a right side seat 14 in the front row of vehicle seats 14, a third floor mat 24c configured for receipt on the vehicle floor 22 in a third footwell 16 that is located by a left side seat 14 in a second row of vehicle seats 14 and a fourth floor mat 24d that is configured for receipt on the vehicle floor 22 in a fourth footwell 16 that is located by a right side seat 14 in the second row of vehicle seats 14. Any number and arrangement of floor mats 24 may be used.

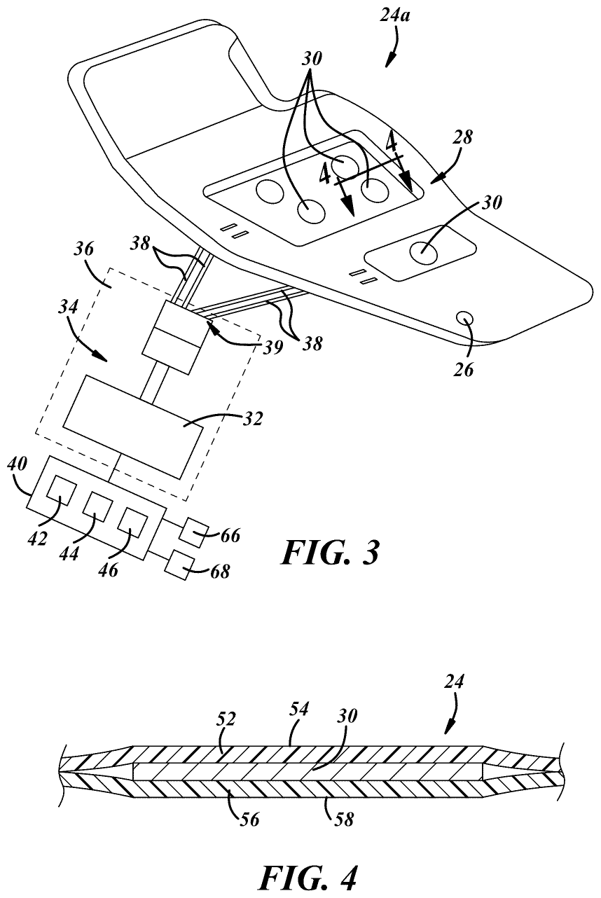

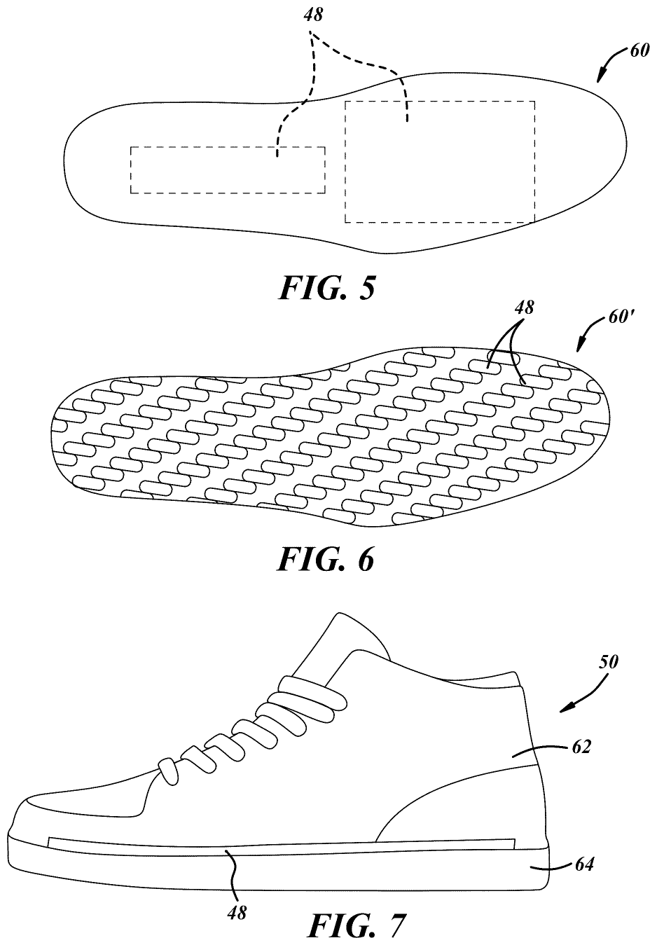

FIG. 3 shows the first floor mat 24 which includes an inductive heating source 28. The inductive heating source 28 includes one or more coils 30 of electrically conductive wire (e.g. copper wire) coupled to an electrical supply 32. In at least some implementations, the electrical supply 32 is part of the vehicle 12, and the coils 30 are electrically coupled to the vehicle 12, for example to a fused electrical circuit 34 that is part of an electrical system 36 of the vehicle 12, by one or more wires 38 (e.g. of a wiring harness 39). The electrical supply 32 may provide an alternating current of a desired magnitude and frequency, to the one or more coils 30. The magnitude and frequency may be managed by a controller 40, and the controller 40 may be carried by the floor mat 24 or other floor covering 25 or part of the vehicle 12, as desired. The controller 40 may include a control circuit 42 with a processor 44 and instructions or programming or switches or other circuit/control elements 46 suitable to manage the current supply to the coils 30. When electricity is supplied to a coil 30, the coil 30 emits magnetic energy (e.g. magnetic flux) in a magnetic field, and the alternating current causes an alternating magnetic field to be emitted. The magnetic flux may cause inductive heating of a heating element 48 (FIGS. 5-7) worn by a passenger, such as in or on a shoe worn by the passenger, as set forth in more details below. In this way, a foot or feet of one or more passengers may be heated while in the vehicle 12. For ease of description, references to the “magnetic field” may refer to energy within the field which is an area in which the magnetic flux energy exists.

The coils 30 are arranged to be directly beneath or adjacent to at least part of a foot of a passenger, and the coils 30 may be of a size or multiple coils 30 may be located spaced apart in the floor mat 24 to enable one or more of the coils 30 to be beneath or adjacent to a passenger foot in different portions of the footwell 16. When electricity is supplied to a coil 30, the coil 30 emits an electromagnetic field or energy that may cause inductive heating of a heating element 48 worn by a passenger, such as in or on a shoe 50 (FIG. 6) worn by the passenger, as set forth in more details below. In this way, a foot or feet of one or more passengers may be heated while in the vehicle 12.

To provide a desired level of inductive heating, the coils 30 may have any desired number of wraps or windings and may be of any desired wire size. The coils 30 may have a diameter of between about three inches to twelve inches, in at least some implementations, to facilitate providing energy to a heating element 48 within a shoe 50 of a vehicle passenger, as set forth in more detail below. In at least some implementations, the coils 30 are arranged to provide energy sufficient to cause inductive heating or a heating element 48 over an area of at least 20 in².

In at least some implementations, the coils 30 may be provided beneath an outer layer or outer surface 51 (FIG. 1) of the floor covering 25 and between the outer layer or surface 51 and the floor 22. For example, the coils 30 may be located beneath the carpet or other floor covering 25 of the vehicle 12, or the coils 30 may be beneath an upper layer 52 or upper surface 54 of material of a floor mat 24. In the example shown in FIG. 4, the floor mat 24 includes an upper layer 52 of material that defines an upper surface 54 of the floor mat 24 on which the foot of a passenger may be received, and a lower or second layer 56 of material that defines a lower surface 58 of the floor mat 24 that may be placed on the floor 22 of the vehicle 12. The coils 30 in this example are embedded within the floor mat 24 and are received between the upper layer 52 or upper surface 54 and the lower surface 58 of the floor mats 24. In this example, the coils 30 are not open or exposed to either the upper surface 54 or the lower surface 58 but the coils 30 could be open/exposed to either or both surfaces 54, 58, if desired. While the floor mat 24 is shown as having two layers 52, 56 of material, the floor mat 24 may have one layer or more than one layer.

In the example of a floor mat 24 formed from a single layer of material, the coils 30 may be connected to a bottom of the floor mat 24 (e.g. at the lower surface of the single layer) or embedded in the single layer of material. By way of a non-limiting example, the floor mat 24 may be formed of or include a layer of molded polymeric material, and the coil or coils 30 may be overmolded (e.g. placed in the mold so that the polymeric material flows over and covers the coils 30) in the floor mats 24 when the floor mats 24 are molded. The coil(s) 30 could be provided elsewhere where a foot or feet of a passenger are placed in use of the vehicle, such as in one or more of the drive control pedals 19.

The heating element 48 may define or be part of an insert 60 received in an interior of a shoe 50 (e.g. an insole), as shown in FIG. 5, and the insert 60 may be either fixed to or removable from the shoe 50, as desired. One or more heating element(s) 48 may be carried by or embedded in the shoe insert 60 (e.g. received between layers of the shoe insert 60, or overmolded in the shoe insert 60), or connected to a lower surface of a shoe insert 60, or simply received beneath the shoe insert 60 and on a base of the shoe interior. As shown in FIG. 6, the heating element could be an integral part of a layer or material of a layer of the shoe insert 60′, with metallic material within the shoe insert. The heating element 48 could also be embedded within a layer or located between layers or portions of the shoe 50. By way of non-limiting examples, as shown in FIG. 7, one or more heating elements 48 may be located between the upper portion 62 and lower portion 64 of the shoe 50, or embedded within the lower portion 64 (which may be formed of a molded polymeric, often elastomeric, material and may define a sole of the shoe). The heating element(s) may span all or most of a surface area of the insert or shoe interior, or any desired part, in different implementations. Further, the heating element 48 could be in or part of clothing, such as a sock, worn by a passenger and need not be part of the shoe 50. In such an arrangement, heating may occur when the passenger's foot is within a shoe 50, or taken out of a shoe 50 and placed on or near the area including the coil(s) 30 (e.g. within the magnetic fields provided by a coil).

The heating element 48 is electrically conductive and is responsive to the magnetic flux emitted in one or more magnetic fields by the one or more coils 30 to cause inductive heating of the heating element 48. The heating element 48 may be defined by or include a metal material, and may include a solid piece of metal or metal material that is woven or otherwise integrated into a fabric, as shown in FIG. 6. Metal or other conductive material may be integrated into a fabric or insert or shoe in any form, such as strands, wires, fibers, powder, foil or mesh, by way of non-limiting examples. In some implementations, the material may be magnetic such as iron, nickel or cobalt, or a non-magnetic and conductive material. Magnetic materials may be heated by hysteresis losses caused by friction between molecules when the material is continuously magnetized in different directions, and also eddy-current losses which occur as a Joule heating effect due to the electric currents induced by the fluctuating magnetic field(s). Non-magnetic heating elements 48 are heated by eddy-current losses. A heating element 48 could include both magnetic and non-magnetic portions if desired.

Thus, the system includes an inductive heating source 28, including one or more coils 30 supplied with an alternating current. The electrical supply 32 may be controlled by a passenger of the vehicle 12 who may actuate an input, such as one or more buttons provided in the cabin or connected to the floor mat, or via menu selections of a software interface made available by way of a vehicle infotainment system 66 (FIG. 3) or climate control system 68 (FIG. 3), by way of non-limiting examples. For example, the electrical supply 32 may be controlled similarly to seat 14 heaters within a vehicle 12, if desired. The current and/or frequency may be varied to alter a level (e.g. rate, intensity or magnitude) of heating, and the current supply may be turned off when heating is not desired. While described in certain implementations as being part of a floor mat 24 within a vehicle footwell 16, the system may be part of a separate mat used in conjunction with a floor mat 24 in the footwell 16. That is, the floor mat 24 of the induction heating system can be an added accessory that is placed on and used with a floor mat 24 and need not define the only floor mat 24 or covering in a footwell 16. In this way, the system can enable feet heating in one or more than one location within the vehicle, as desired. The vehicle, in turn, can be wired or include connections for wiring for one or more than one location of heating, to provide power to each intended area, as desired.

The inductive heating does not require direct contact between the coils 30 and the heating element 48 and can be done wirelessly, that is, without a wire connected to the heating element 48. Further, the electrical energy need not come from a battery or other portable power source carried or worn by the passenger and can instead come from a vehicle electric power source. The heating element 48 may be worn by the passenger and need not remain in the vehicle 12. A user may have inductive heating sources outside of the vehicle as well, and so can warm their feet with the in-vehicle system and also systems outside the vehicle. Without a wired connection or direct contact being needed or a portable power supply being needed, the inductive foot heater system is very convenient for users. Further, the inductive heating occurs in the heating element 48 itself and heating can occur rapidly enabling fast and comfortable heating.

What is claimed is:

1. A vehicle, comprising:
a cabin having a seat and a footwell associated with the seat; and
an inductive heating source having an electrical supply and one or more coils located in the footwell and connected to the electrical supply, wherein, when an alternating current is provided to the one or more coils, the one or more coils emit one or more magnetic fields adapted to enable inductive heating of a heating element in the one or more magnetic fields.

2. The vehicle of claim 1 which also includes a floor mat received in the foot well, the floor mat carrying the one or more coils.

3. The vehicle of claim 2 wherein the floor mat includes an upper layer of material that defines an upper surface of the floor mat on which a foot of a passenger may be received, and the one or more coils are received beneath the upper layer of material.

4. The vehicle of claim 3 wherein the floor mat includes a second layer of material that is beneath the upper layer of material, and wherein the one or more coils are received between the second layer of material and the upper layer of material.

5. The vehicle of claim 3 wherein the one or more coils are overmolded into the floor mat.

6. The vehicle of claim 1 wherein the footwell is defined at least in part by a floor of the vehicle and the vehicle includes a floor covering on the floor, and wherein the one or more coils are received between the floor and the floor covering.

7. The vehicle of claim 1 wherein multiple coils are provided in the footwell, the multiple coils including individual coils that are spaced apart from each other and are received in an area of at least 20 in².

8. The vehicle of claim 1 which also includes a controller coupled to the electrical supply and to the one or more coils, wherein the controller is adapted to control the magnitude or frequency or both of the electricity supplied to the one or more coils.

9. A floor mat for a vehicle, comprising:
an upper layer of material that defines an upper surface of the floor mat adapted to receive a foot of a vehicle passenger may be received; and
one or more coils of wire adapted to be connected to a source of alternating current and to emit one or more magnetic fields adapted to enable inductive heating of a heating element in the one or more magnetic fields, wherein the one or more coils are received beneath the upper surface of the floor mat.

10. The floormat of claim 9 wherein the one or more coils are received beneath the upper layer of material.

11. The floormat of claim 9 wherein the floor mat includes a second layer of material that is beneath the upper layer of material, and wherein the one or more coils are received between the second layer of material and the upper layer of material.

12. The floormat of claim 9 wherein the floor mat is defined by or includes a polymeric layer and the one or more coils are overmolded into the polymeric layer.

13. The floormat of claim 9 which also includes a controller coupled to the one or more coils and arranged to control one or both of a magnitude and frequency of the alternating current supplied to the one or more coils.

14. The floormat of claim 9 wherein the one or more coils includes multiple coils that are spaced apart from each other and are received in an area of at least 20 in².

15. The floormat of claim 9 wherein the coils are received on a lower surface of the floormat or otherwise at least partially exposed to the lower surface.
